(19) United States
(12) Patent Application Publication
(10) Pub. No.: US 2026/0249119 A1
(43) Pub. Date: Aug. 27, 2026

(54) FIRE EXTINGUISHING ROBOT, CLUSTER OF FIRE EXTINGUISHING ROBOTS, AND FIRE EXTINGUISHING METHOD

(71) Applicants: JIANGSU XCMG CONSTRUCTION MACHINERY RESEARCH INSTITUTE LTD., Xuzhou, Jiangsu (CN); XCMG FIRE-FIGHTING SAFETY EQUIPMENT CO., LTD., Xuzhou, Jiangsu (CN)

(72) Inventors: Kang LIANG, Xuzhou, Jiangsu (CN); Yong ZHANG, Xuzhou, Jiangsu (CN); Zhigang GAO, Xuzhou, Jiangsu (CN); Junyin CHEN, Xuzhou, Jiangsu (CN)

(21) Appl. No.: 18/871,176

(22) PCT Filed: Jul. 26, 2023
(86) PCT No.: PCT/CN2023/109326

§ 371 Date: Dec. 3, 2024

(30) Foreign Application Priority Data
Aug. 26, 2022 (CN) 202211037499.4

(51) Int. Cl. A62C 31/24; A62C 27/00

(52) U.S. Cl. CPC A62C 31/24; A62C 27/00

(57) ABSTRACT

The present disclosure provides a fire extinguishing robot, a cluster of fire extinguishing robots and a fire extinguishing method, which relate to the field of firefighting apparatuses and are used to improve the structure and performance of fire extinguishing robots. The fire extinguishing robot includes a traveling mechanism, a frame, and a water receiving portion. The traveling mechanism is configured to travel; the frame is mounted on the traveling mechanism; the water receiving portion is mounted on the periphery of the frame, and encircles the periphery of the frame; the water receiving portion includes a cavity for accommodating a fire extinguishing agent, and the cavity is open. The above-mentioned technical solution does not require receiving externally conveyed fire extinguishing agent by means of a water hose. Instead, there is a water receiving portion, and the water receiving portion is open, which receives the fire extinguishing agent sprayed from high altitude. The fire extinguishing robot sprays the fire extinguishing agent received by its own water receiving portion via its own fire monitor, for extinguishing the fire or providing it to a fire extinguishing robot located downstream. The solution has a compact structure and a small load, and it achieves remote spraying and fire extinguishing at any distance.

### CROSS-REFERENCE TO RELATED APPLICATIONS

The present disclosure is based on and claims priority to Chinese Patent Application No. 202211037499.4, filed on Aug. 26, 2022, the entire contents of which are incorporated herein by reference.

### BACKGROUND OF THE INVENTION

### Field of the Invention

The present disclosure relates to the field of firefighting apparatuses, and specifically relates to a fire extinguishing robot, a cluster of fire extinguishing robots and a fire extinguishing method.

### Description of Related Art

In recent years, petrochemical fires frequently occur, posing a serious threat to the safety of people's lives and property. A petrochemical fire site has high temperature and is filled with toxic and harmful gases, accompanied by a high risk of explosion, and it is difficult for rescuers to reach the site for rescue. Petrochemical fire is one of the four typical fire rescue challenges at home and abroad. Fire extinguishing robots, as rescue apparatuses for replacing rescuers to approach dangers, are gradually popularized and applied in recent years. Meanwhile, the existing fire extinguishing robots all require providing a fire extinguishing agent through a water hose system.

The inventors have found that related art at least has the following problems: (1) the water hose after being filled with liquid is extremely heavy, and it is difficult to drag the water hose, which seriously limits the moving distance of the robot. (2) The water hose after being filled with liquid cannot contract autonomously, so that the fire extinguishing robot can only move forwards and cannot move backwards. (3) The water hose is liable to entanglement, wear and cut, which causes interruption of liquid supply and influences the fire extinguishing effect.

### BRIEF SUMMARY OF THE INVENTION

The present disclosure proposes a fire extinguishing robot, a cluster of fire extinguishing robots and a fire extinguishing method, which are used to improve the structure and performance of fire extinguishing robots.

Embodiments of the present disclosure provide a fire extinguishing robot, including:
a traveling mechanism configured to travel;
a frame mounted on the traveling mechanism; and
a water receiving portion mounted on the periphery of the frame and encircling the periphery of the frame; wherein the water receiving portion includes a cavity for accommodating a fire extinguishing agent, and the cavity is open.

In some embodiments, the fire extinguishing robot further includes: a firefighting pipeline in fluid communication with the water receiving portion; the firefighting pipeline being carried by the frame.

In some embodiments, the firefighting pipeline is in fluid communication with a lowermost part of the water receiving portion.

In some embodiments, the fire extinguishing robot further includes: an arm support mounted on the frame; at least one section of the firefighting pipeline being mounted on the arm support so as to vary the amplitude along with the arm support.

In some embodiments, the water receiving portion includes:
a plurality of first side plates which enclose a closed annular shape;
a bottom plate configured to be annular; the plurality of first side plates being mounted on an inner edge of the bottom plate; and
a plurality of second side plates mounted on an outer edge of the bottom plate; the second side plates also enclosing a closed annular shape; the first side plates, the second side plates and the bottom plate together enclosing the cavity.

In some embodiments, an angle between the second side plates and the bottom plate is greater than 90°.

In some embodiments, the water receiving portion further includes: a shielding member mounted on the first side plates for shielding a top of the frame.

In some embodiments, the fire extinguishing robot is configured as an unmanned system.

In some embodiments, the fire extinguishing robot is configured to be hose-free.

In some embodiments, the fire extinguishing robot further includes:
a control system mounted on the frame to control traveling and fire extinguishing parameters of the fire extinguishing robot; and
a remote control system in communication connection with the control system, the remote control system configured to transmit control parameters to the control system.

In some embodiments, the fire extinguishing parameters include at least one of: a flow rate of the fire extinguishing agent, a spraying direction of the fire extinguishing agent, a spraying angle of the fire extinguishing agent and a distance from a burning point.

Embodiments of the present disclosure provide a cluster of fire extinguishing robots, including at least two of the fire extinguishing robots provided by any technical solution of the present disclosure.

In some embodiments, one group consists of at least two of the fire extinguishing robots, and the fire extinguishing robots in the same group are arranged in sequence. The fire extinguishing robot located downstream is at a spraying point of the fire extinguishing robot located upstream, and the fire extinguishing robot located upstream sprays the fire extinguishing agent to the water receiving portion of the fire extinguishing robot located downstream.

In some embodiments, the fire extinguishing robot located upstream sprays the fire extinguishing agent to the water receiving portion of the adjacent fire extinguishing robot located downstream.

Embodiments of the present disclosure provide a fire extinguishing method, including the following steps:
the fire extinguishing robot with no fire extinguishing agent provided by any technical solution of the present disclosure travels to a set position;
at least one fire extinguishing robot conveys the fire extinguishing agent to another fire extinguishing robot;
the another fire extinguishing robot conveys the fire extinguishing agent to an origin of fire to extinguish the fire.

In some embodiments, all the fire extinguishing robots that participate in fire extinguishment are the fire extinguishing robots provided by any technical solution of the present disclosure.

The fire extinguishing robot provided by the technical solution described above has no water hose, and it does not require receiving the externally conveyed fire extinguishing agent by means of a water hose. Instead, it has a water receiving portion which is open and receives the fire extinguishing agent sprayed from high altitude. The fire extinguishing robot sprays the fire extinguishing agent received by its own water receiving portion via its own fire monitor, for extinguishing the fire or providing it to a fire extinguishing robot located downstream. The fire extinguishing robot has a compact structure, a light weight, a small load and it is flexible in movement, and it achieves remote spraying and fire extinguishing at any distance.

### BRIEF DESCRIPTION OF THE DRAWINGS

The drawings illustrated here are used for providing further understanding of the present disclosure and constitute part of the present application. The exemplary embodiments of the present disclosure and description thereof are used for interpreting the present disclosure, not constituting improper limitations of the present disclosure. In the drawings:

FIG. 1 is a schematic perspective view of the structure of a fire extinguishing robot provided by embodiments of the present disclosure.

FIG. 2 is another schematic perspective view of the structure of the fire extinguishing robot provided by embodiments of the present disclosure.

FIG. 3 is a schematic view of the relative position of a water receiving portion, a frame and a traveling mechanism of the fire extinguishing robot provided by embodiments of the present disclosure.

FIG. 4 is another schematic view of the relative position of a water receiving portion, a frame and a traveling mechanism of the fire extinguishing robot provided by embodiments of the present disclosure.

FIG. 5 is a schematic perspective view of the structure of the water receiving portion of the fire extinguishing robot provided by embodiments of the present disclosure.

FIG. 6 is a schematic view of an unfolded state of an arm support of the fire extinguishing robot provided by embodiments of the present disclosure.

FIG. 7 is a schematic view of an operating state of a cluster of fire extinguishing robots provided by embodiments of the present disclosure.

FIG. 8 is a schematic view of a fire extinguishing method provided by embodiments of the present disclosure.

### REFERENCE SIGNS

1. traveling mechanism; 2. frame; 3. water receiving portion; 4. firefighting pipeline; 5. arm support; 6. water pump; 7. electric push rod; 8 power battery; 9. rotary support; 10. fire monitor;
11. control system; 12. remote control system;
201. turntable; 202. covering member;
30. cavity; 31. first side plate; 32. bottom plate; 33. second side plate; 34. shielding member; 310. rectangular hole; 311. water pump connection hole; 313. threaded hole;
321. first sub-plate; 322. second sub-plate;
41. upper truck firefighting pipeline; 42. lower truck firefighting pipeline.

### DETAILED DESCRIPTION OF THE INVENTION

The technical solution provided by the present disclosure is explained in more detail below with reference to FIGS. 1 to 8.

At a petrochemical fire site, the temperature is very high, and it is filled with toxic and harmful gases, accompanied by a high risk of explosion. It is very difficult to extinguish a petrochemical fire, and the danger coefficient is very high. Embodiments of the present disclosure provide a fire extinguishing robot which is an unmanned system. The fire extinguishing robot sprays a fire extinguishing agent according to a control strategy. Fire fighters do not need to get close to the burning point, which greatly reduces the danger of the fire fighters in fire extinguishment. Moreover, the fire extinguishing robot does not require a water hose to convey the fire extinguishing agent, so it has also overcome various defects of the system with a water hose. The fire extinguishing robot is more flexible in movement, the moving distance is not limited by the length of the water hose, and the supply of the fire extinguishing agent will be interrupted due to entanglement and damage of the water hose. The fire extinguishing robot provided by embodiments of the present disclosure is an unmanned system. It does not need a driver, and it does not require the fire fighters to get close to the fire extinguishing robot to provide it with a fire extinguishing agent. Moreover, the fire extinguishing robot does not use a water hose to convey the fire extinguishing agent from the exterior of the fire extinguishing robot to the interior of the fire extinguishing robot. Instead, it adopts a spraying method in which externally conveyed fire extinguishing agent is sprayed into a water receiving portion 3 of the fire extinguishing robot and then conveyed from the water receiving portion 3 to the interior of the fire extinguishing robot. The fire extinguishing agent is for example water, or another liquid having a fire extinguishing effect.

Referring to FIG. 1, the fire extinguishing robot includes a traveling mechanism 1, a frame 2, and a water receiving portion 3. The frame 2 is mounted on the traveling mechanism 1, and is configured to travel under the driving of the traveling mechanism 1. The water receiving portion 3 is mounted on the periphery of the frame 2, and the water receiving portion 3 encircles the periphery of the frame 2; the water receiving portion 3 includes a cavity 30 for accommodating a fire extinguishing agent, and the cavity 30 is open.

Specifically, the traveling mechanism 1 is used to travel of the fire extinguishing robot, and it is implemented in various manners, such as a wheeled traveling mechanism, a tracked traveling mechanism. A tracked traveling mechanism has a large contact area with the ground, and it is more suitable for soft and slippery places. A wheeled traveling mechanism moves faster, with more flexible steering, and it is more suitable for hard ground.

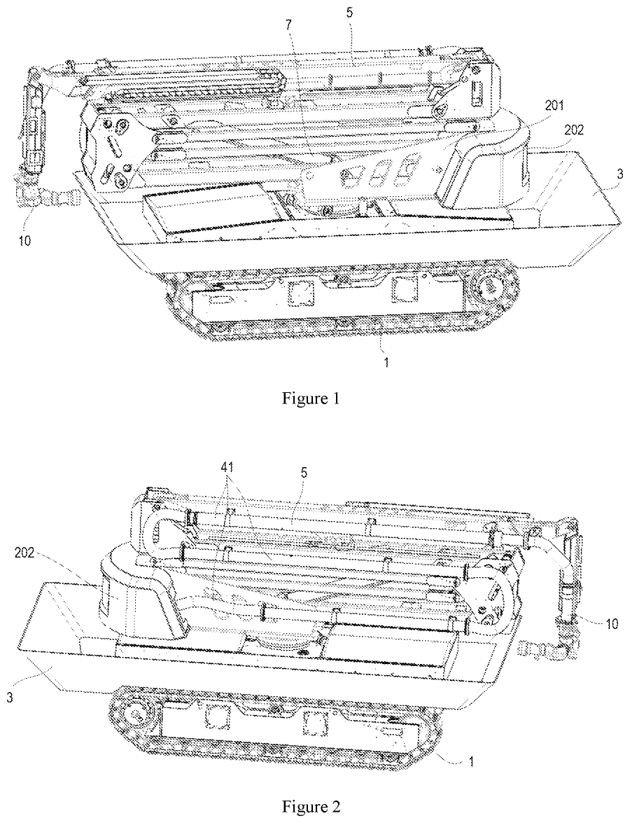

Referring to FIGS. 1 and 2, one track is provided on either edge of the frame 2 in a width direction, and the tracks carry the weight of the frame 2 and the parts mounted on the frame 2. Two tracks are used for joint load-carrying such that the load-carrying of the fire extinguishing robot is more balanced and steady.

The frame 2 is mounted on the traveling mechanism 1 and is carried by the traveling mechanism 1. A control system 11 related to the control of the fire extinguishing robot is mounted inside the frame 2. The control system 11 is not exposed, so that the operation reliability of the whole fire extinguishing robot is higher, to prevent the control system 11 from losing control in the presence of water or prevent other dangers from occurring, when the water receiving portion 3 receives the sprayed fire extinguishing agent.

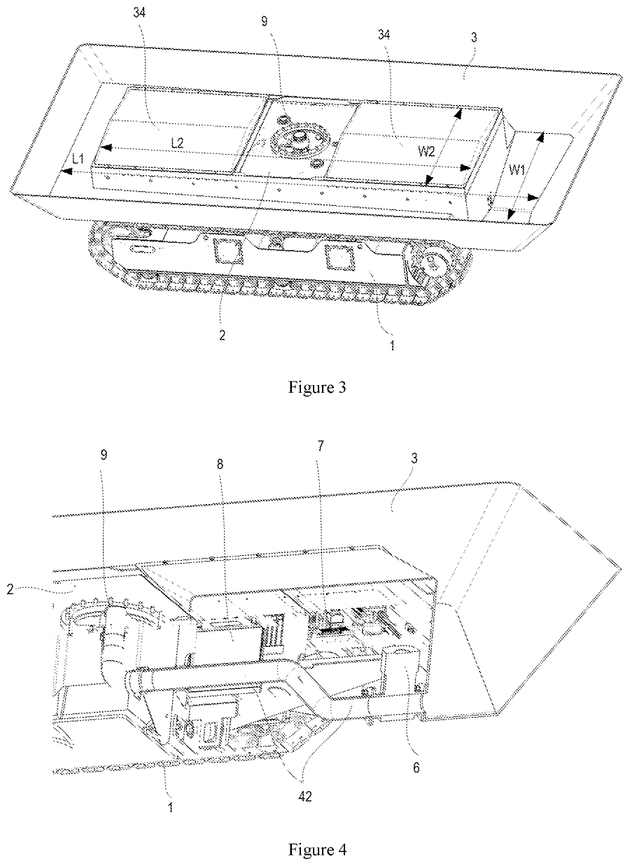

Referring to FIGS. 3 and 5, the water receiving portion 3 encircles the periphery of the frame 2, and the water receiving portion 3 surrounds the periphery of the frame 2 once. The water receiving portion 3 is open. The fire extinguishing agent in the water receiving portion 3 is from another fire extinguishing robot, and the other fire extinguishing robot sprays the fire extinguishing agent in its own water receiving portion 3 via its own fire monitor 10 to the water receiving portion 3 of the aforementioned fire extinguishing robot. A size of the opening of the water receiving portion 3 is made larger than a size of the frame 2. Taking a water receiving portion 3 and a frame 2 having a shape similar to a rectangle as an example, a length dimension L1 of the water receiving portion 3 is greater than a length dimension L2 of the frame 2, and a width dimension W1 of the water receiving portion 3 is greater than a width dimension W2 of the frame 2. Taking a water receiving portion 3 with an inverted trapezoidal structure as an example, the minimum opening dimension (the dimension of the bottom of the trapezoid) L1 of the water receiving portion 3 in the length direction is greater than the maximum length dimension L2 of the frame 2. The minimum opening dimension (the dimension of the bottom of the trapezoid) L1 of the water receiving portion 3 in the width direction is greater than the maximum width dimension L2 of the frame 2. This reduces the difficulty in aiming when the other fire extinguishing robot sprays the fire extinguishing agent and makes it possible to easily aim at the water receiving portion 3 of the fire extinguishing robot so as to convey the fire extinguishing agent to the water receiving portion 3 of the fire extinguishing robot.

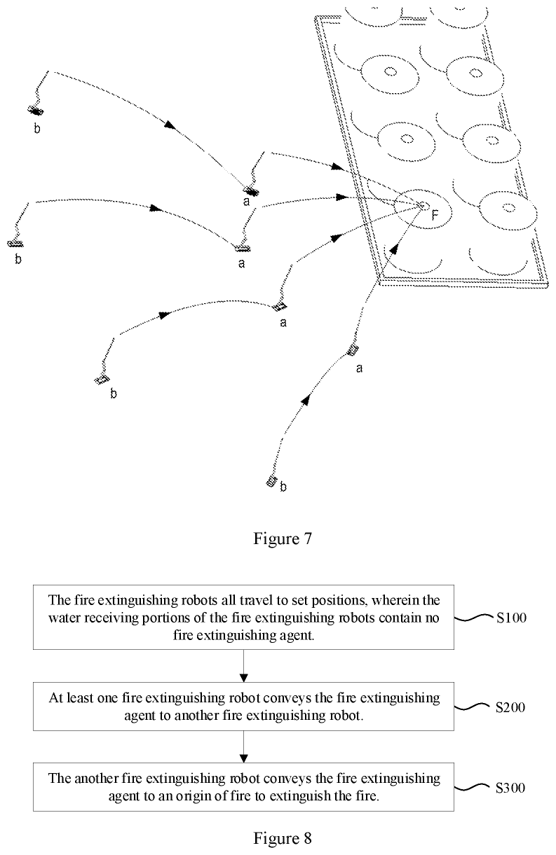

Referring to FIG. 7, the fire extinguishing agent is sprayed to the fire extinguishing robot in one-to-one correspondence, i.e., one fire extinguishing robot is used to provide the fire extinguishing agent to another fire extinguishing robot. In FIG. 7, one-to-one correspondence is adopted, that is, one fire extinguishing robot is used to spray the fire extinguishing agent to another fire extinguishing robot. Considering that the fire extinguishing agent may leak or splash when entering the water receiving portion 3, it is also possible to use a plurality of fire extinguishing robots to spray the fire extinguishing agent to the same fire extinguishing robot.

Referring to FIGS. 3 to 5, a specific way of implementation of the water receiving portion 3 is described below.

In some embodiments, the water receiving portion 3 includes a plurality of first side plates 31, a bottom plate 32, and a plurality of second side plates 33.

Referring to FIG. 5, the plurality of first side plates 31 enclose a closed annular shape, and the annular shape matches the shape of the outer peripheral surface of the frame 2. The number of the first side plates 31 is the same as that of the outer side surfaces that the frame 2 has. Taking the frame 2 having a shape similar to a rectangular parallelepiped as an example, there are four first side plates 31. The four first side plates 31 enclose a rectangular hole 310, and the frame 2 is mounted in the rectangular hole 310. Each first side plate 31 is fixedly connected with the frame 2 by a connection member such as a bolt. As shown in FIG. 5, one set of opposing first side plates 31 are both provided with a plurality of threaded holes 313. Screw holes (not shown in the drawing) are also provided at corresponding positions of the frame 2. The frame 2 and the first side plates 31 are fixedly connected by bolts 35 passing through the threaded holes 313 and the screw holes. A water pump connection hole 311 is provided on one of the other set of opposing first side plates 31. A water pump 6 is mounted on the frame 2, and the water pump 6 pumps the fire extinguishing agent in the cavity 30 of the water receiving portion 3 into a firefighting pipeline 4.

Referring to FIG. 5, for the bottom plate 32, a V-shaped structure arranged in an inclined manner or a structure with a lowest part formed by piecing together a plurality of plates or other means are used. Under the action of gravity, the fire extinguishing agent in the water receiving portion 3 is automatically collected at the lowest part of the bottom plate 32. The water pump connection hole 311 also corresponds to the lowest part of the bottom plate 32, which enables the water pump 6 to convey all the fire extinguishing agent collected in the water receiving portion 3 into the firefighting pipeline 4. Referring to FIG. 5, in some embodiments, the bottom plate 32 includes a first sub-plate 321 and a second sub-plate 322. The first sub-plate 321 is located higher than the second sub-plate 322, and the second sub-plate 322 is located lower. The first sub-plate 321 is arranged to be inclined at an inclination angle of 2°~5°. The end (first end) of the first sub-plate 321 toward the second sub-plate 322 is lower, and the end (second end) of the first sub-plate 321 away from the second sub-plate 322 is higher. The fire extinguishing agent flows from the second end to the first end of the first sub-plate 321 and finally flows into the second sub-plate 322 which is lower than the first end. A V-shaped plate with two sides having an inclination angle is used as the second sub-plate 322. Along a width direction W of the second sub-plate 322, two ends of the second sub-plate 322 are top ends of the V-shaped plate, and the middle of the second sub-plate 322 is a bottom end of the V-shaped plate. The fire extinguishing agent in the water receiving portion 3 is all collected at the lowest part of the second sub-plate 322. The water pump connection hole 311 is located at the bottom of the first side plate 31 and corresponds to the lowest part of the second sub-plate 322, which makes it convenient for the water pump 6 to suck the fire extinguishing agent.

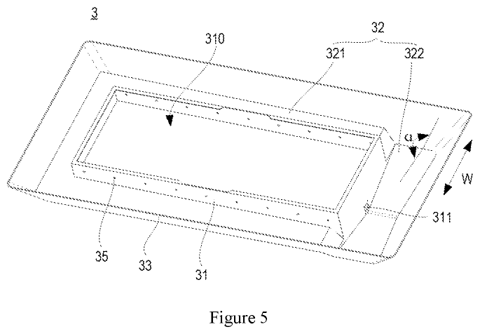

Referring to FIG. 4, a vertical centrifugal pump is used as the water pump 6, and the firefighting pipeline 4 is in fluid communication with the water receiving portion 3; the firefighting pipeline 4 is carried by the frame 2. The firefighting pipeline 4 includes two parts: an upper truck firefighting pipeline 41, and a lower truck firefighting pipeline 42. The fire monitor 10 is connected with the upper truck firefighting pipeline 41. The upper truck firefighting pipeline 41 is arranged along the arm support 5, and is connected with the lower truck firefighting pipeline 42 via a central hole of a rotary support 9. The upper truck firefighting pipeline 41 varies the amplitude with the amplitude variation of the arm support 5. The lower truck firefighting pipeline 42 is in communication with the water receiving portion 3 via the vertical centrifugal pump. The fire extinguishing agent within the water receiving portion 3 enters the water pump 6 through the water pump connection hole 311, is pressurized by the water pump 6, and then sequentially passes through the lower truck firefighting pipeline 42, the upper truck firefighting pipeline 41 and the fire monitor 10 to spray water or extinguish a fire. An electrically controlled fire monitor 10 is specifically used as the fire monitor 10, and the electrically controlled fire monitor 10 remotely controls the spraying angle.

Referring to FIG. 4, in some embodiments, the firefighting pipeline 4 is in fluid communication with the lowermost part of the water receiving portion 3. Under the action of the vertical centrifugal pump, water is sucked from the water receiving portion 3 into the lower truck firefighting pipeline 4, then conveyed to the upper truck firefighting pipeline 4, and finally sprayed out of the fire monitor 10.

The bottom plate 32 is annular, the plurality of first side plates 31 are mounted on an inner edge of the bottom plate 32, and multiple connection methods may be used between the bottom plate 32 and each first side plate 31, such as welding fixation and sheet metal forming.

The plurality of second side plates 33 are mounted on an outer edge of the bottom plate 32. The second side plates 33 also enclose a closed annular shape. The first side plates 31, the second side plates 33 and the bottom plate 32 together enclose the open cavity 30. The fire extinguishing agent enters the cavity 30 through an opening at the top of the cavity 30, then is collected at the lowest part of the second sub-plate 322 under the action of its own gravity, and then is pumped to the lower truck firefighting pipeline 42 by the water pump 6, then enters the upper truck firefighting pipeline 41, and finally is sprayed out of the fire monitor 10.

The joints of the bottom plate 32, the first side plates 31 and the second side plates 33 are all sealed. The joints of adjacent second side plates 33 and the joints of adjacent first side plates 31 are all sealed. The fire extinguishing agent cannot leak through the joints.

With continued reference to FIG. 5, in some embodiments, an angle between the second side plates 33 and the bottom plate 32 is greater than 90°. That is, the second side plates 33 are flared with respect to the bottom plate 32, so that the water receiving portion 3 is presented as a flared structure with a larger opening at the upper end and a smaller opening at the lower end, which makes it easier to receive the fire extinguishing agent sprayed by other fire extinguishing robots.

Referring to FIG. 3, the water receiving portion 3 further includes a shielding member 34, and the shielding member 34 is mounted on the first side plates 31, for shielding on the outside of the top of the frame 2. The shielding member 34 is such that the fire extinguishing agent will not be sprayed into the interior of the frame 2, allowing the system to operate normally.

Referring to FIG. 2 and FIG. 1, in some embodiments, a turntable 201 is mounted at the top of the frame 2, a portion of the turntable 201 exposed from the frame 2 is covered with a covering member 202, and the covering member 202 also has a blocking effect so that the fire extinguishing agent will not be sprayed into the interior of the turntable 201, so that the system operates normally.

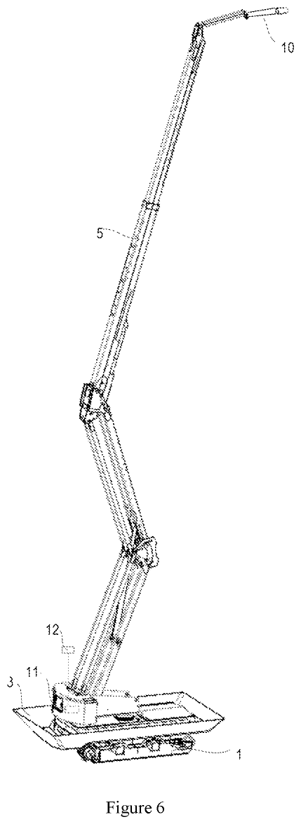

Referring to FIGS. 1 and 6, in some embodiments, the fire extinguishing robot further includes an arm support 5 which is mounted on the frame 2 and specifically mounted on the rotary support 9. The arm support 5 is a multi-joint folding arm support. The unfolding height of the arm support 5 is in direct proportion to the number of joints, and the larger the number of joints, the higher the unfolding height of the arm support 5. The rotary support 9 carries the arm support 5 to rotate so as to change the spraying direction. At least one section of the firefighting pipeline 4, specifically the upper truck firefighting pipeline 4, is mounted on the arm support 5 so as to vary the amplitude along with the arm support 5. When the arm support 5 is retracted to the proper position, the arm support 5 is completely placed on a top surface of the frame 2, and the arm support 5 shields a part of the opening of the cavity 30, as shown in FIG. 1. When the arm support 5 is completely unfolded, the arm support 5 completely leaves the opening of the cavity 30, and the whole of the opening of the cavity 30 receives the fire extinguishing agent sprayed from other fire extinguishing robots.

On the circumference of a circle formed with the fire extinguishing robot receiving the fire extinguishing agent as the center and with the spraying range (spraying distance) as the radius, a plurality of fire extinguishing robots may be arranged to provide the fire extinguishing agent to the aforementioned robot. The arrangement is more flexible in orientation, and the fire extinguishing requirement of narrow and complex environment will be better met. Of course, the spraying range of each fire extinguishing robot is adjustable, and it is also possible to use fire extinguishing robots with different spraying ranges to provide the fire extinguishing agent to the robot.

It should be noted here that the spraying direction refers to the position of the arm support 5 relative to the frame 2. The spraying angle refers to the angle of the fire monitor 10 relative to the arm support 5, i.e., at which pitching angle the fire monitor 10 sprays the fire extinguishing agent.

In order to realize amplitude variation of the arm support 5, the fire extinguishing robot further includes an electric push rod 7 and a power battery 8 which are electrically connected, and the power battery 8 provides electric power to the electric push rod 7. The electric push rod 7 is in driving connection with the arm support 5 to realize amplitude variation of the arm support 5. When the electric push rod 7 extends out, the arm support 5 is unfolded; and when the electric push rod 7 retracts, the arm support 5 retracts. The action of the electric push rod 7 is controlled by a control system 11 described later. Of course, a controller may be provided separately for the electric push rod 7.

As introduced above, the fire extinguishing robot is an unmanned system. In some embodiments, the fire extinguishing robot further includes a control system 11 and a remote control system 12. The control system 11 is mounted on the frame 2 to control traveling and fire extinguishing parameters of the fire extinguishing robot. The remote control system 12 and the control system 11 are in communication connection, and specifically, in wireless communication connection. The remote control system 12 is configured to transmit control parameters to the control system 11. The remote control system 12 is, for example, a remote controller, a control screen on a firefighting truck, etc.

The control system 11 moves synchronously with the fire extinguishing robot, and the control system 11 is in communication connection with each of the electric push rod 7 introduced above, the control part of the traveling mechanism 1, the fire monitor 10, etc. Corresponding control signals about the traveling distance of the fire extinguishing robot, its parking position, the amplitude variation angle of the arm support 5, the spraying direction and the spraying angle of the fire extinguishing agent, and the flow rate of the fire extinguishing agent are all transmitted to the control system 11 through the remote control system 12, to perform control.

Referring to FIGS. 6 and 7, embodiments of the present disclosure also provide a cluster of fire extinguishing robots, which includes at least two of the fire extinguishing robots provided by any technical solution of the present disclosure.

In some embodiments, at least two fire extinguishing robots form one group, and the fire extinguishing robots in the same group are arranged in sequence. The fire extinguishing robot located downstream is at a spraying point of the fire extinguishing robot located upstream, and the fire extinguishing robot located upstream sprays the fire extinguishing agent to the water receiving portion 3 of the fire extinguishing robot located downstream.

A plurality of fire extinguishing robots are arranged in series to form a cluster, and they cooperate with each other to extinguish a fire. In some embodiments, one cluster includes multiple groups of fire extinguishing robots arranged in series, each group including multiple fire extinguishing robots. FIG. 7 shows one cluster including four groups of fire extinguishing robots, each group including two fire extinguishing robots.

One group is taken as an example and described in detail. The fire extinguishing robot closest to the burning point is referred to as a first-stage fire extinguishing robot a, and the next closest one is referred to as a second-stage fire extinguishing robot b. The second-stage fire extinguishing robot b sprays the fire extinguishing agent to the first-stage fire extinguishing robot a, and the first-stage fire extinguishing robot a sprays the fire extinguishing agent that is has received to the burning point F via its own fire monitor 10. The fire extinguishing robot of the stage farthest from the burning point F carries the fire extinguishing agent and move to a set position; alternatively, it may be arranged directly adjacent to a source of fire extinguishing agent, and the fire extinguishing robot moves without carrying the fire extinguishing agent. The arrows in FIG. 7 illustrate the flow direction of the fire extinguishing agent.

Depending on the spraying distance of the fire extinguishing robots, in some embodiments, a fire extinguishing robot located upstream sprays the fire extinguishing agent to the water receiving portion 3 of an adjacent fire extinguishing robot located downstream. In this way, the spraying distance of each fire extinguishing robot is utilized to the maximum extent to realize short-distance fire extinguishment.

Referring to FIG. 8, embodiments of the present disclosure also provide a fire extinguishing method using fire extinguishing robots, including the following steps:

Step 100: the fire extinguishing robots provided by any technical solution of the present disclosure travel to set positions, wherein the water receiving portion 3 of the fire extinguishing robots is in a state in which no fire extinguishing agent is contained.

The set positions of respective fire extinguishing robots are different. Specifically, the distances from respective fire extinguishing robots in each group to the burning point are different. The first-stage fire extinguishing robot a is closest to the burning point and farthest from the source of fire extinguishing agent. The fire extinguishing robot of the last stage is farthest from the burning point and closest to the source of fire extinguishing agent.

When moving to the set position, each fire extinguishing robot moves in an empty state. That is, the fire extinguishing robots move without carrying the fire extinguishing agent and without dragging a fire extinguishing agent conveying member such as a water hose. The water receiving portion 3 of the fire extinguishing robots is empty.

Step S200: at least one fire extinguishing robot conveys the fire extinguishing agent to another fire extinguishing robot.

With fire extinguishing robots of five stages as an example, a fifth-stage fire extinguishing robot sprays the fire extinguishing agent from the source of fire extinguishing agent to the water receiving portion 3 of a fourth-stage fire extinguishing robot, the fourth-stage fire extinguishing robot sprays the fire extinguishing agent to the water receiving portion 3 of a third-stage fire extinguishing robot, the third-stage fire extinguishing robot sprays the fire extinguishing agent to the water receiving portion 3 of a second-stage fire extinguishing robot, the second-stage fire extinguishing robot sprays the fire extinguishing agent to the water receiving portion 3 of a first-stage fire extinguishing robot, and the first-stage fire extinguishing robot sprays the fire extinguishing agent to the fire extinguishing point to extinguish the fire. Moreover, this cluster of fire extinguishing robots has outstanding long-range fire extinguishing capability, and no matter how far away it is from the burning point, it extinguishes the fire by increasing the number of the fire extinguishing robots arranged in series.

The fire extinguishing agent is provided in one-to-one correspondence as shown in FIG. 7, or is provided in many-to-one correspondence.

One-to-one correspondence is as follows: one fifth-stage fire extinguishing robot corresponds to one fourth-stage fire extinguishing robot, one fourth-stage fire extinguishing robot corresponds to one third-stage fire extinguishing robot, one third-stage fire extinguishing robot corresponds to one second-stage fire extinguishing robot, and one second-stage fire extinguishing robot corresponds to one first-stage fire extinguishing robot.

Many-to-one correspondence is as follows: a plurality of fifth-stage fire extinguishing robots are used to provide the fire extinguishing agent to one fourth-stage fire extinguishing robot, a plurality of fourth-stage fire extinguishing robots are used to provide the fire extinguishing agent to the same third-stage fire extinguishing robot, a plurality of third-stage fire extinguishing robots are used to provide the fire extinguishing agent to the same second-stage fire extinguishing robot, and a plurality of second-stage fire extinguishing robots are used to provide the fire extinguishing agent to the same first-stage fire extinguishing robot.

The above-mentioned fire extinguishing robots with a water receiving portion 3 may also be used as the fifth-stage fire extinguishing robots, so that the fire extinguishing robots of each stage is exchanged. Of course, since the fifth-stage fire extinguishing robots do not need to receive fire extinguishing agent sprayed by other members, it is also possible to use common fire extinguishing robots with no water receiving portion 3 as the fifth-stage fire extinguishing robots.

Step S300: the another fire extinguishing robot conveys the fire extinguishing agent to an origin of fire to extinguish the fire.

The whole cluster of fire extinguishing robots include multiple groups of fire extinguishing robots, and the number of the fire extinguishing robots in each group may be the same or different. They may be placed at adjacent positions so as to extinguish the same burning point together; and they may also be dispersed to extinguish different burning points. Each group of robots is controlled relatively independently so as to achieve more targeted fire extinguishing operation.

In description of the present disclosure, it needs to be appreciated that orientation or position relations denoted by the terms “center”, “longitudinal”, “transverse”, “front”, “rear”, “left”, “right”, “vertical”, “horizontal”, “top”, “bottom”, “inner”, “outer” and the like are orientation or position relations illustrated based on the drawings, are merely for the convenience of describing the present disclosure and simplifying description, instead of indicating or implying the denoted devices or elements must have specific orientations or be constructed and operated in specific orientations, and thus the terms cannot be construed as limiting the protection scope of the present disclosure.

Finally, it should be noted that the above embodiments are only used for describing rather than limiting the technical solutions of the present disclosure. Although the present disclosure is described in detail with reference to the preferred embodiments, those of ordinary skill in the art should understand that they still make modifications to the specific implementations in the present disclosure or make equivalent substitutions to part of technical features thereof; and such modifications and equivalent substitutions should be encompassed within the scope of the technical solutions sought for protection in the present disclosure so long as they do not depart from the spirit of the technical solutions of the present disclosure.

1. A fire extinguishing robot; comprising:
a traveling mechanism configured to travel;
a frame mounted on the traveling mechanism and
a water receiving portion mounted on the periphery of the frame and encircling the periphery of the frame
wherein the water receiving portion comprises a cavity for accommodating a fire extinguishing agent, and the cavity is open.

2. The fire extinguishing robot according to claim 1, further comprising:
a firefighting pipeline in fluid communication with the water receiving portion; the firefighting pipeline being carried by the frame

3. The fire extinguishing robot according to claim 2, wherein the firefighting pipeline is in communication with a lowermost part of the water receiving portion.

4. The fire extinguishing robot according to claim 2, further comprising:
an arm support mounted on the frame at least one section of the firefighting pipeline being mounted on the arm support so as to vary the amplitude along with the arm support.

5. The fire extinguishing robot according to claim 1, wherein the water receiving portion comprises:
a plurality of first side plates which enclose a closed annular shape;
a bottom plate configured to be annular; and
a plurality of second side plates enclosing a closed annular shape;
the plurality of first side plates being mounted on an inner edge of the bottom plate;
the plurality of second side plates mounted on an outer edge of the bottom plate; and
the first side plates the second side plates, and the bottom plate together enclosing the cavity.

6. The fire extinguishing robot according to claim 5, wherein an angle between the second side plates and the bottom plate is greater than 90°.

7. The fire extinguishing robot according to claim 5, wherein the water receiving portion further comprises:
a shielding member mounted on the first side plates for shielding a top of the frame.

8. The fire extinguishing robot according to claim 1, wherein the fire extinguishing robot is configured to be at least one of an unmanned system and hose-free.

9. The fire extinguishing robot according to claim 1, further comprising:
a control system mounted on the frame control traveling and fire extinguishing parameters of the fire extinguishing robot; and
a remote control system in communication connection with the control system the remote control system being configured to transmit control parameters to the control system

10. The fire extinguishing robot according to claim 9, wherein the fire extinguishing parameters comprise at least one of: a flow rate of the fire extinguishing agent, a spraying direction of the fire extinguishing agent, a spraying angle of the fire extinguishing agent, and a distance from a burning point.

11. A cluster of fire extinguishing robots, comprising at least two of the fire extinguishing robots according to claim 1.

12. The cluster of fire extinguishing robots according to claim 11, wherein one group consists of at least two of the fire extinguishing robots, and the fire extinguishing robots in the same group are arranged in sequence, the fire extinguishing robot located downstream is at a spraying point of the fire extinguishing robot located upstream, and the fire extinguishing robot located upstream sprays the fire extinguishing agent to the water receiving portion of the fire extinguishing robot located downstream.

13. The cluster of fire extinguishing robots according to claim 12, wherein the fire extinguishing robot located upstream sprays the fire extinguishing agent to the water receiving portion of the adjacent fire extinguishing robot located downstream.

14. A fire extinguishing method, comprising:
a plurality of fire extinguishing robots with no fire extinguishing agent according to claim 1 all travel to set positions;
at least one fire extinguishing robot conveys the fire extinguishing agent to another fire extinguishing robot; and
the another fire extinguishing robot conveys the fire extinguishing agent to an origin of fire to extinguish the fire.

15. The fire extinguishing method according to claim 14, wherein all the fire extinguishing robots participate in the fire extinguishment.
